(19) United States
(12) Patent Application Publication
(10) Pub. No.: US 2019/0199280 A1
(43) Pub. Date: Jun. 27, 2019

(54) BODY-MOUNTED SOLAR PANEL CARRIER

(71) Applicant: Trinity Integrity, LLC, San Diego, CA (US)

(72) Inventors: Gabriel Carrillo, San Diego, CA (US); Eugene Gonzalez, San Diego, CA (US)

(73) Assignee: Trinity Integrity, LLC, San Diego, CA (US)

(21) Appl. No.: 16/028,027

(22) Filed: Jul. 5, 2018

Related U.S. Application Data
(60) Provisional application No. 62/501,560, filed on May 4, 2017.

(51) Int. Cl. H02S 30/10; H02S 99/00; F16M 13/04

(52) U.S. Cl. CPC H02S 30/10; F24S 2025/01; F16M 13/04; H02S 99/00

(57) ABSTRACT

The disclosure concerns a body-mounted solar panel carrier comprising a support assembly configured to be worn with a harness, a panel-receiving assembly configured to receive and secure one or more solar panel(s), and a plurality of support linkages configured to connect the support assembly to the panel-receiving assembly such that the panels are offset from the user's body. The panel-receiving assembly is adapted to sit at a position removed from the support assembly but maintains the weight of the solar panel therein to be evenly distributed across a person's body via the shoulder straps, and lumbar support. This allows a user to: (i) secure a solar panel to the carrier at the panel-receiving assembly, (ii) don the body-mounted solar panel carrier via the pair of shoulder straps and lumbar support of the support assembly, (iii) safely walk with the carrier and solar panel, and (iv) safely ascend a ladder while maintaining four points of contact, with said body-mounted solar panel carrier and solar panel in tow.

### CROSS-REFERENCE TO RELATED APPLICATIONS

This application claims benefit of priority with U.S. Prov. Ser. No. 62/501,560, filed May 4, 2017; the entire contents of which are hereby incorporated by reference.

### BACKGROUND OF THE INVENTION

### Field of the Invention

This invention relates to carriers for solar panels, and more particularly, to a body-mounted solar panel carrier for transporting solar panels and other construction materials to rooftops and other elevated platforms.

### Description of the Related Art

Solar panels are regularly installed on the roof of residential and commercial property units. There is a high demand for an economical solution to safely transport the solar panels from the ground level onto a roof for installation.

The prior art contains a myriad of hoisting systems and apparatuses for the purpose of hoisting and transporting solar panels onto a roof. However, there is a need for a safe low cost solution, which allows a person to utilize both hands in an unrestricted manner while climbing a ladder or otherwise transporting the solar panels.

Hoisting devices and pulleys are often expensive, and require qualified personnel to install them prior to use at each job site. Hoisting devices, such as pulleys, also present an added liability for business owners if they are not installed properly, or if they fail.

Often times workers bypass these more complicated approaches and simply drag the solar panels up with them as they ascend a ladder. This naturally raises a safety concern because it is mandated that workers maintain four points of contact whenever ascending a ladder.

These and other problems in the art are solved with the disclosure of a solar panel carrier as provided herein.

### SUMMARY OF THE INVENTION

The disclosure concerns a body-mounted solar panel carrier for carrying solar panels, the carrier comprising a support assembly, a panel-receiving assembly, and a plurality of support linkages coupled therebetween. The support assembly generally functions as a backpack harness, with an optional lumbar support, for attaching the solar panel carrier to a body of a user. The panel-receiving assembly generally functions to receive and hold one or more solar panels, or planar objects, for stabilized carrying to a delivery site. The support linkages are rigid structures designed to offset the payload (solar panels, etc.) such that they do not impose a threat or make contact which might restrict movement of the user.

The body-mounted solar panel carrier allows a user to: (i) secure a solar panel to the carrier at the panel-receiving assembly, (ii) don the body-mounted solar panel carrier via the pair of shoulder straps and optional lumbar support of the support assembly, (iii) safely walk with the carrier and solar panel, and (iv) safely ascend a ladder while maintaining four points of contact, with said body-mounted solar panel carrier and solar panel(s) in tow.

### BRIEF DESCRIPTION OF THE DRAWINGS

FIG. 1 shows a body-mounted solar panel carrier configured to transport a mounted solar panel to a delivery site.

FIG. 2 shows a front view of the body-mounted solar panel carrier in accordance with a first illustrated embodiment.

FIG. 3 shows a rear view of the body-mounted solar panel carrier in accordance with the first illustrated embodiment.

FIG. 4 shows a side view of the body-mounted solar panel carrier in accordance with a second illustrated embodiment.

FIG. 5 shows an exploded view of the body-mounted solar panel carrier in accordance with the second illustrated embodiment.

FIG. 6A shows a first configuration of a hinged slot for use in conjunction with the body-mounted solar panel carrier in accordance with the second illustrated embodiment.

FIG. 6B shows a first configuration of a hinged slot for use in conjunction with the body-mounted solar panel carrier in accordance with the second illustrated embodiment.

FIG. 6C shows a first configuration of a hinged slot for use in conjunction with the body-mounted solar panel carrier in accordance with the second illustrated embodiment.

### DETAILED DESCRIPTION OF THE PREFERRED EMBODIMENTS

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review hereof. Accordingly, any reviewer of the instant disclosure should interpret the scope of the invention by the claims, and such scope shall not be limited by the embodiments described and illustrated herein.

In a general embodiment the body-mounted solar panel carrier comprises: a support assembly and a panel-receiving assembly, each of the support assembly and panel-receiving assembly being connected by a plurality of linkages extending therebetween.

The support assembly comprises a support frame, a shoulder harness, and an optional lumbar support, each arranged to form a backpack-type assembly termed herein a “support assembly”. The support frame is generally fabricated from metal, preferably a lightweight metal, such as aluminum. However, one with skill in the art would appreciate various alternatives for fabricating the support assembly, including composites such as fiberglass and carbon fiber type materials.

The panel-receiving assembly comprises an annular frame (which may also be referred to as “annular panel-receiving frame” to distinguish from the support frame of the support assembly. The annular frame includes a pair of opposing corner slots coupled to left and right bottom corners thereof, respectively. Each of the opposing corner slots is configured to receive one or more solar panels therein. Above the corner slots are shown a pair of opposing upper slots, the upper slots being configured to further hold the solar panels. The upper slots may be u-shaped slots as shown or may further include a latching mechanism for opening to allow insertion of the one or more solar panels and closing for securing the solar panels therein. A multitude of alternative designs may be similarly implemented, such as bars extending across the annular frame creating a receiving portion for receiving solar panels therein. While the preferred embodiment is illustrated in the instant disclosure, one with skill in the art will appreciate multiple possible embodiments which effectively receive one or more solar panels for temporary engagement and holding by the annular frame.

Each of the plurality of linkages comprises a proximal end and a distal end, the proximal end being attached to the support assembly, the distal end is attached to the annular frame of the panel-receiving assembly, wherein the linkages support the panel-receiving assembly at a position spaced away from the support assembly. In this regard, the solar panels may be positioned away from a user's head or other anatomical extremities.

The body-mounted solar panel carrier is characterized as being configured to: (i) secure a solar panel to the carrier at the panel-receiving assembly, (ii) allow a user to don the body-mounted solar panel carrier via the pair of shoulder straps and lumbar support of the support assembly, (iii) allow a user to safely walk with the carrier and solar panel, and (iv) allow a user to safely ascend a ladder while maintaining four points of contact, with said body-mounted solar panel carrier and solar panel in tow.

### Example 1

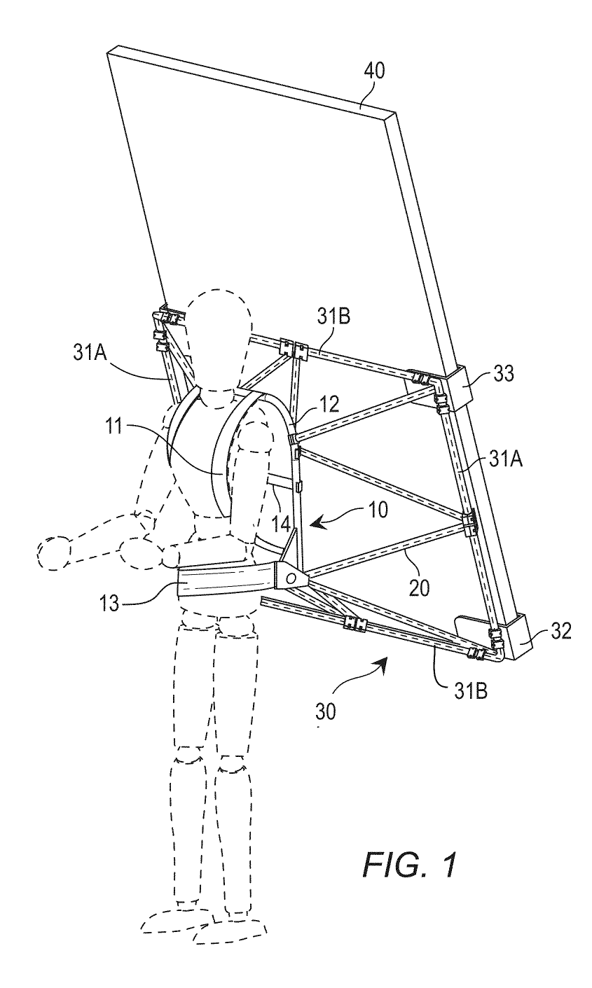

Now, turning to the drawings, FIG. 1 shows how a user would wear the body-mounted solar panel carrier for the purpose of transporting a mounted solar panel 40 or other planar objects to a delivery site, such as for example, a building rooftop. The body-mounted solar panel carrier for solar panels comprises: a support assembly 10 and a panel-receiving assembly 30, connected by a plurality of linkages 20 extending therebetween. The body of a user is shown in broken lines for illustrating how a person wears the cattier.

The support assembly comprises a support frame 12, a shoulder harness 11, and an optional lumbar support 13. In this embodiment, the shoulder harness comprises a pair of shoulder straps. Also, in this embodiment, the support assembly comprises a plurality of lateral supports 14 (behind user) and lumbar support 13. As one skilled the art will appreciate, these supports can be substituted in other embodiments depending on the preference or needs of the user. For example, in place of a tubular frame as shown, a planar plastic or composite frame may be provided. Alternatively, various features can be added (ex: multiple lateral supports or vertical supports) or reconfigured without departing from the spirit and scope of the invention.

The panel-receiving assembly 30 comprises a plurality of vertical bars 31A and a plurality of horizontal bars 31B, with two of the vertical bars being spaced apart and joined to the horizontal bars to form a rectangular outer periphery of a carrier frame (31B; 31B), herein collectively termed an “annular frame” or “annular panel-receiving frame” because the frame may comprise any annular shape. The panel-receiving assembly further comprises a first corner slot, and a second corner slot (corner slots 32) with the second corner slot being oriented to oppose the first corner slot. Each of the corner slots 32 are mounted at the corresponding bottom corners of the annular frame. Moreover, a first upper slot, and a second upper slot (upper slots 33) with the second upper slot being oriented to oppose the first upper slot, are each mounted at a position on the annular frame above the corner slots. In this regard, the upper and lower (corner) slots utilize the least material for providing a solar panel receiving portion (compared to other possible embodiments), thereby providing the least weight of the carrier which greatly improves usability.

Each of the plurality of linkages 20 includes a proximal end, and a distal end opposite the proximal end, wherein the proximal end is attached to the support assembly 10 and the distal end is attached to the annular frame 30. In this regard, the linkages 20 support the panel-receiving assembly at a position spaced away from the support assembly.

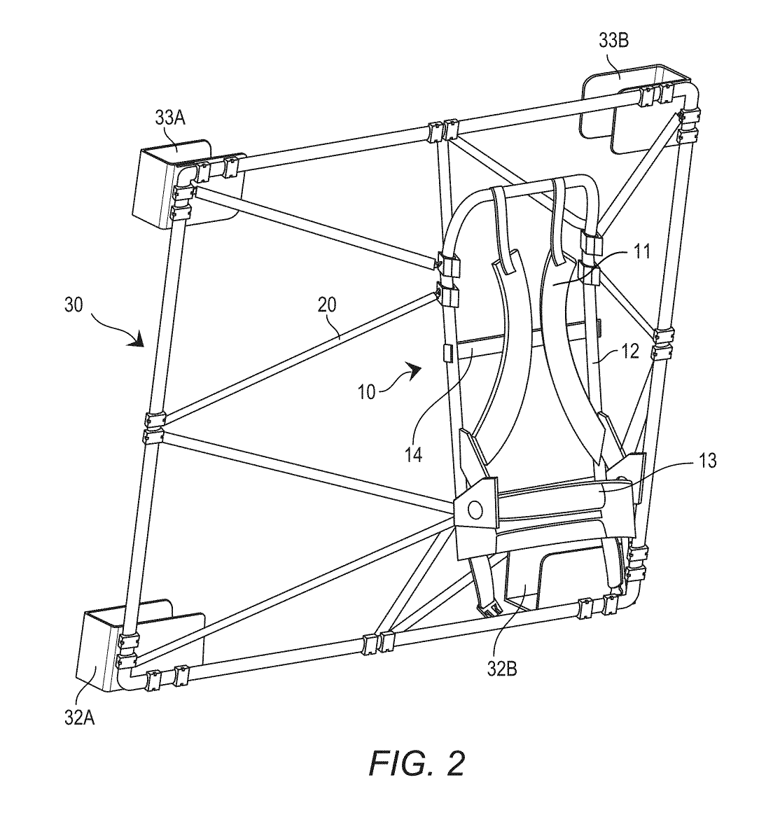

FIG. 2 shows a front-side view of the body-mounted solar panel carrier. The support frame 12, the shoulder harness 11, and the lumbar support 13 collectively form the support assembly 10. As shown, the support frame can be further reinforced by optional lateral supports 14. The shoulder harness generally may include a pair of shoulder straps which are configured to engage the shoulders of a user. The lumbar support is optional, although preferred.

Additionally, the corner slots 32 and the upper slots 33 of the panel-receiving assembly are slotted to receive a solar panel therebetween, generally forming a “channel”. The corner slots may generally comprise a first corner slot 32A and a second corner slot 32B. In addition, the upper slots may generally comprise a first upper slot 33A and a second upper slot 33B as shown. As one skilled the art will appreciate, these slots can be substituted in other embodiments depending on the preference or needs of the user. For example, the upper slots might embody adjustable or ratcheting clamps, or the two corner slots might be substituted for a single bucket with a hinged door similar to a folding or hinged planar sheet (not shown). Generally, the panel receiving assembly is configured with a “channel” for receiving and holding solar panels.

As shown, the support assembly 10 is spaced apart from the panel-receiving assembly 30 via a plurality of linkages 20 extending therebetween. The linkages form a key aspect of the invention, in that the panel-receiving assembly is offset from the support frame. It will be noted that the linkages extend away from the support assembly creating an angle of the linkages such that movement of the arms or other anatomical extremities of a user will not be impeded by the panel-receiving assembly itself. This is important for safety and allowing a user to climb a ladder with the carrier being worn.

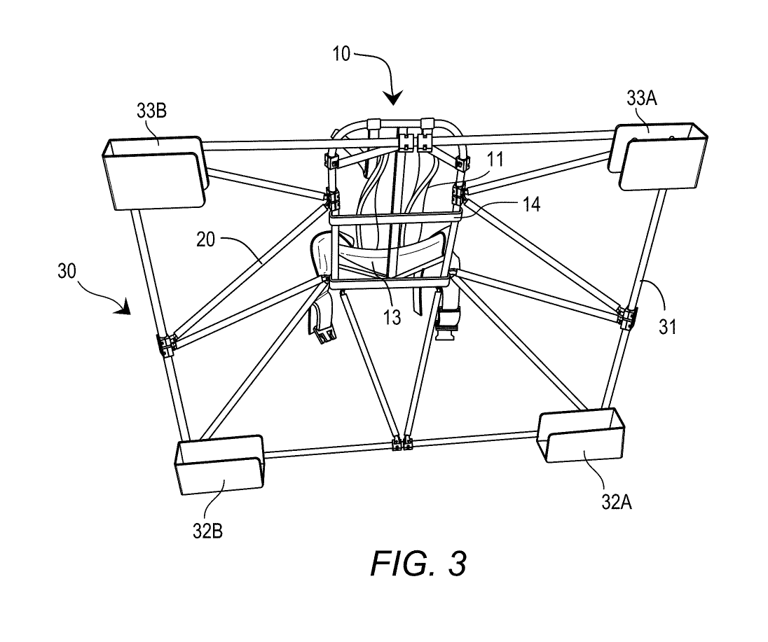

FIG. 3 shows a rear-side view of the body-mounted solar panel carrier in accordance with the illustrated embodiment. Here, from a distinct view is further shown the panel-receiving assembly 30 comprising an annular panel receiving frame 31, first and second corner slots 32A; 32B, respectively, and first and second upper slots 33A; 33B, respectively. The panel-receiving assembly 30 is shown coupled to the support frame 10 via linkages 20 extending therebetween. Here, the support frame 10 is shown comprising a pair of shoulder straps forming a harness 11; an optional lumbar support 13; and optional lateral supports 14 for reinforcing the structure of the support frame.

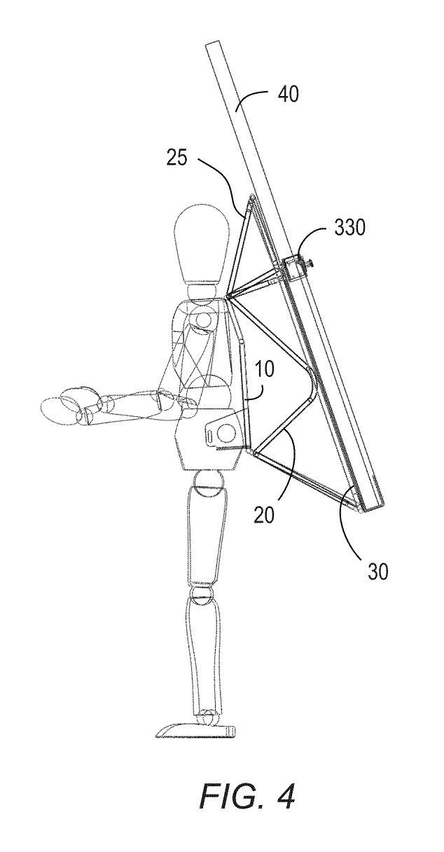

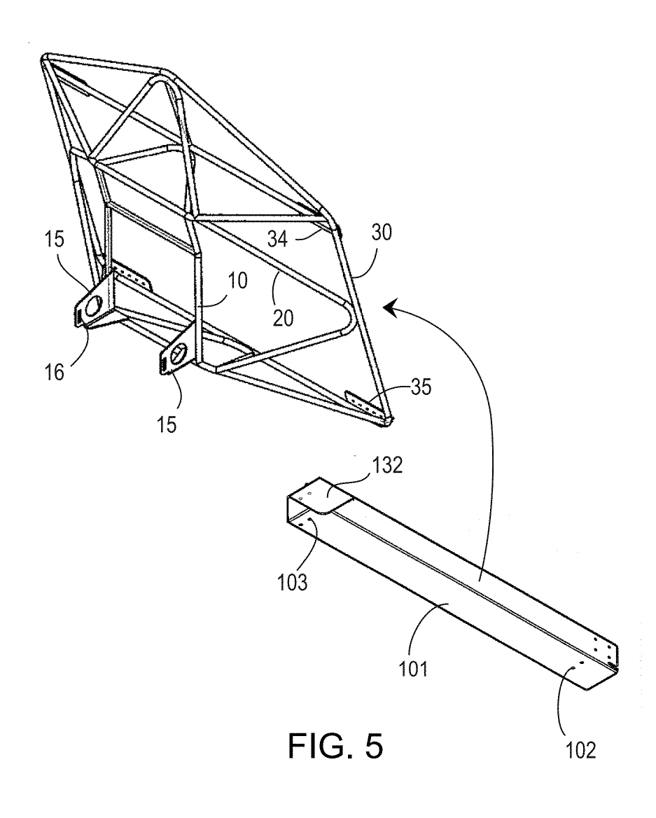

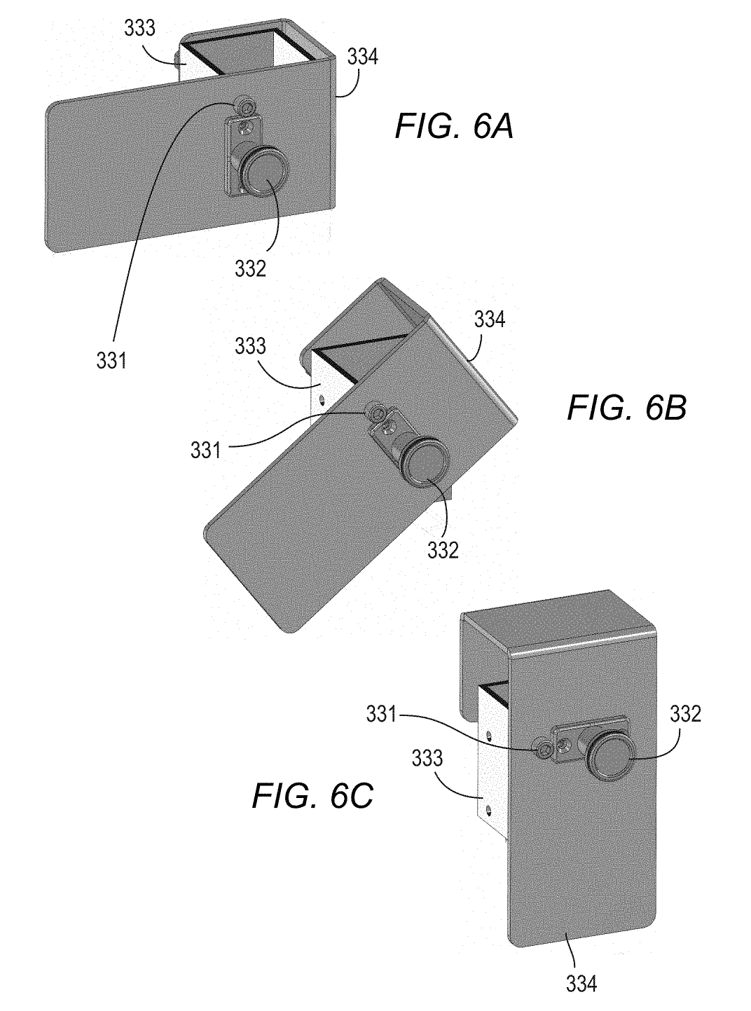

Now turning to a second illustrated embodiment, FIG. 4 shows a side view of the body-mounted solar panel carrier. In this embodiment, the body-mounted solar panel carrier comprises a support assembly 10, a panel-receiving assembly 30, and a plurality of linkages 20 extending between the support assembly and the panel-receiving assembly, and further includes a head-guard 25 disposed at an upper end of the carrier. In addition, the carrier comprises frame rails capable of selectively mounting to upper and lower rail plates (FIG. 5) of the panel-receiving assembly for adjusting a width of the channel within which the solar panel(s) can be held. In this regard, by mounting the frame rails in one of a plurality of possible positions about the rail plates, the width of the solar panel receiving channel can be customized for a particular job. Finally, the upper slot comprises a hinged upper slot (“hinged-slot”) 330 which is configured to lock into each of: (i) a first position in a closed-configuration for maintaining the solar panels in the channel of the carrier, and (ii) a second position in an open-configuration for enabling lateral removal of the solar panel(s) from the channel portion of the carrier. Additional details of one embodiment of the hinged-slot are further illustrated in FIG. 6 and described below.

FIG. 5 shows an exploded view of the body-mounted solar panel carrier in accordance with the second illustrated embodiment. Here, the carrier includes a support assembly 10, a panel-receiving assembly 30, and a plurality of linkages 20 extending between the support assembly and the panel-receiving assembly. The rail plates include upper rail plates 34 and lower rail plates 35, typically welded or otherwise attached to the panel-receiving assembly. Opposing frame rails 101 (mirror opposite for opposing side not shown) are mounted to the upper and lower rail plates via conventional hardware at a width to be selected by a user. The frame rails comprise upper holes 102 and lower holes 103, through which the conventional hardware is inserted during attachment. Built-in to the frame rails are corner slots 132. The support assembly further comprises a pair of belt flanges 15, each with belt apertures 16 integrated therewith.

FIGS. 6(A-C) show a hinged-slot for use with the carrier in the second illustrated embodiment.

FIG. 6A shows a first configuration of a hinged-slot for use in conjunction with the body-mounted solar panel carrier in accordance with the second illustrated embodiment. The hinged-slot comprises a slot-body 334 coupled to a slot-base 333 via a slot-pin 331 extending therethrough. In addition, the hinged-slot comprises a slot-catch 332 configured for pulling in order to release the catch from a notch in the slot-base, wherein the hinged slot is configured in one of two positions about the slot-base using the slot-catch. In this view, the hinged slot is configured in a first position (closed). The slot-base is generally fixed to the frame rails using conventional hardware. Generally, the slot-catch includes a spring-loaded feature biasing force against the catch for maintaining a position about the base. However, one with skill in the art may freely implement other similar mechanical designs which accomplish substantially the same benefit of opening and closing the upper hinged-slot for capturing/releasing the solar panel(s) within the channel of the carrier.

FIG. 6B shows a first configuration of a hinged slot for use in conjunction with the body-mounted solar panel carrier in accordance with the second illustrated embodiment. Here, the slot-catch 332 is pulled to allow rotation of the slot-body 334 about the slit-pin 331 relative to the slot-base 333.

FIG. 6C shows a first configuration of a hinged slot for use in conjunction with the body-mounted solar panel carrier in accordance with the second illustrated embodiment. Once the slot body is rotated completely, the slot-catch 332 engages a notch of the slot-base 333 to lock into place. As-shown the hinged slot is in a second position in an open configuration for allowing removal of the solar panels from a channel of the carrier.

Now, although particular features and embodiments have been described in an effort to enable one with skill in the art to make and use the claimed invention, it should be understood that several variations, alterations or substitutions can be achieved to arrive at a carrier for solar panels comprising a support assembly and a panel-receiving assembly connected via a plurality of linkages. Nothing in this description shall be construed as limiting the spirit and scope of the invention as set forth by this provisional application.

### FEATURE LIST

Support assembly (10)
Harness (11)
Support Frame (12)
Lumbar Support (13)
Lateral Support (14)
Belt Flange (15)
Belt Aperture (16)
Linkage (20)
Head Guard (25)
Panel-receiving assembly (30)
Annular Panel-Receiving Frame (31)
Corner Slot (32)
Upper Slot (33)
Upper Rail Plate (34)
Lower Rail Plate (35)
Solar Panel (40)
Frame Rail (101)
Upper Frame Rail Holes (102)
Lower Frame Rail Holes (103)
Rail Corner Slot (132)
Hinged Slot (330)
Slot-pin (331)
Slot-catch (332)
Slot-base (333)
Slot-body (334)

What is claimed is:

1. A body-mounted solar panel carrier, comprising:
a support assembly, the support assembly including:
a support frame, and
a shoulder harness coupled to the support frame and configured to engage the shoulders of a user;
a panel-receiving assembly, the panel-receiving assembly including:
an annular panel-receiving frame having a top end and a bottom end thereof,
a pair of opposing upper slots being disposed adjacent to the top end of the annular frame, and
a pair of opposing corner slots being disposed adjacent to the bottom end of the annular structure; and
a plurality of linkages extending between the support assembly and the panel-receiving assembly.

2. The body-mounted solar panel carrier of claim 1, wherein the opposing upper slots are disposed between the top end and the bottom end of the annular structure.

3. The body-mounted solar panel carrier of claim 1, said support assembly further comprising a lumbar support coupled to the support frame and configured to wrap around the waist of the user.

4. The body-mounted solar panel carrier of claim 1, wherein each of the support assembly, panel-receiving assembly, and linkages therebetween collectively form a body-mounted solar panel carrier configured to receive and retain one or more solar panels for manual transportation from a first location to a second location.

5. The body-mounted solar panel carrier of claim 1, wherein the support frame further comprises a lateral support bar.

6. The body-mounted solar panel carrier of claim 1, wherein the support frame further comprises two or more lateral support bars, each extending between two sides of the support frame.

7. The body-mounted solar panel carrier of claim 1, wherein the linkages form an angle with respect to a first plane associated with the support frame.

8. The body-mounted solar panel carrier of claim 1, wherein the linkages form an angle with respect to a second plane associated with the annular panel-receiving frame.

9. A body-mounted solar panel carrier, comprising: a support assembly, a panel-receiving assembly, and a plurality of linkages extending between the support assembly and the panel-receiving assembly.

10. A body-mounted solar panel carrier, comprising:
a support assembly, the support assembly including:
a support frame, and
a shoulder harness coupled to the support frame and configured to engage the shoulders of a user;
a panel-receiving assembly, the panel-receiving assembly including:
an annular panel-receiving frame, and
a channel for receiving solar panels; and
a plurality of linkages extending between the support assembly and the panel-receiving assembly.

11. The body-mounted solar panel carrier of claim 10, the annular panel-receiving frame having a top end and a bottom end thereof, and a pair of opposing upper slots being disposed adjacent to the top end of the annular frame.

12. The body-mounted solar panel carrier of claim 11, wherein the opposing upper slots are disposed between the top end and the bottom end of the annular structure.

13. The body-mounted solar panel carrier of claim 10, said support assembly further comprising a lumbar support coupled to the support frame and configured to wrap around the waist of the user.

14. The body-mounted solar panel carrier of claim 10, wherein each of the support assembly, panel-receiving assembly, and linkages therebetween collectively form a body-mounted solar panel carrier configured to receive and retain one or more solar panels for manual transportation from a first location to a second location.

15. The body-mounted solar panel carrier of claim 10, wherein the support frame further comprises a lateral support bar.

16. The body-mounted solar panel carrier of claim 10, wherein the support frame further comprises two or more lateral support bars, each extending between two sides of the support frame.

17. The body-mounted solar panel carrier of claim 10, wherein the linkages form an angle with respect to a first plane associated with the support frame.

18. The body-mounted solar panel carrier of claim 10, wherein the linkages form an angle with respect to a second plane associated with the annular panel-receiving frame.

19. The body-mounted solar panel carrier of claim 10, further comprising a head-guard.

20. The body-mounted solar panel carrier of claim 10, further comprising: a hinged-slot, adjustable frame rails, or a combination thereof.
